(19) United States
(12) Patent Application Publication
(10) Pub. No.: US 2020/0011682 A1
(43) Pub. Date: Jan. 9, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Shinichi OKABE, Nagakute-shi (JP); Hiroaki SAKURAI, Nagoya-shi (JP); Kazuaki TAKEMURA, Nagoya-shi (JP); Kengo TAKEUCHI, Ogaki-shi (JP); Kaori SAKAI, Tokyo-to (JP); Hideo HASEGAWA, Nagoya-shi (JP)

(73) Assignee: TOYOTA JIDOSHA KABUSHIKI KAISHA, Toyota-shi (JP)

(21) Appl. No.: 16/502,193

(22) Filed: Jul. 3, 2019

(30) Foreign Application Priority Data
Jul. 3, 2018 (JP) 2018-126687

(51) Int. Cl. G01C 21/34; G01C 21/36; G06Q 50/30

(52) U.S. Cl. CPC G01C 21/3438; G06Q 50/30; G01C 21/3691; G01C 21/343

(57) ABSTRACT

A processor provided in an information processing apparatus is configured to acquire trip information about trips of a plurality of vehicles in a predetermined region, specify, among the trips of the plurality of vehicles, based on the trip information, a trip with respect to which a travel route of a first vehicle includes a departure point and an arrival point of a travel route of a second vehicle, and generate information indicating an effect of ride-sharing on traffic by assuming establishment of ride-sharing in the first vehicle for the trip that is specified.

### CROSS REFERENCE TO RELATED APPLICATION

This application claims the benefit of Japanese Patent Application No. 2018-126687, filed on Jul. 3, 2018, which is hereby incorporated by reference herein in its entirety.

### BACKGROUND

### Technical Field

The present disclosure relates to an information processing apparatus and an information processing method.

### Description of the Related Art

Conventionally, there is known a technique for enabling a user driving a vehicle to check a desired boarding location and a desired alighting location of another user with respect to a scheduled route of the vehicle driven by the user (Patent document 1).

### CITATION LIST

### Patent Document

[Patent document 1] Japanese Patent Laid-Open No. 2018-55538

The present disclosure has an object to provide a technology for evaluating a potential effect of ride-sharing in a vehicle.

### SUMMARY

One aspect of the present disclosure is an information processing apparatus comprising a processor configured to:

acquire trip information about trips of a plurality of vehicles in a predetermined region;

specify, among the trips of the plurality of vehicles, based on the trip information, a trip with respect to which a travel route of a first vehicle includes a departure point and an arrival point of a travel route of a second vehicle, wherein the first vehicle and the second vehicle are included in the plurality of vehicles; and

generate information indicating an effect of ride-sharing on traffic by assuming establishment of ride-sharing in the first vehicle for the trip that is specified.

Another aspect of the present disclosure is an information processing method performed by a computer, the method comprising:

acquiring trip information about trips of a plurality of vehicles in a predetermined region;

specifying, among the trips of the plurality of vehicles, based on the trip information, a trip with respect to which a travel route of a first vehicle includes a departure point and an arrival point of a travel route of a second vehicle, wherein the first vehicle and the second vehicle are included in the plurality of vehicles; and

generating information indicating an effect of ride-sharing on traffic by assuming establishment of ride-sharing in the first vehicle for the trip that is specified.

According to the present disclosure, a potential effect of ride-sharing in a vehicle may be quantitatively evaluated.

### BRIEF DESCRIPTION OF DRAWINGS

FIG. 1 is a schematic system diagram illustrating an example of an evaluation system according to an embodiment;

FIG. 2 is a block diagram illustrating an example of a configuration of a vehicle and a management server according to an embodiment;

FIG. 3 is a diagram illustrating an example of a structure of a drive history information table according to an embodiment;

FIG. 4 is a diagram illustrating an example of a structure of a travel history information table according to an embodiment;

FIG. 5 is a flowchart illustrating an example flow of an evaluation process according to an embodiment; and

FIG. 6 is a flowchart illustrating an example of a subroutine of the evaluation process according to an embodiment.

### DESCRIPTION OF THE EMBODIMENTS

Ride-sharing in a vehicle is desirable from the standpoint of reduction in occurrence of traffic congestion and reduction in a load on the environment, for example. Ride-sharing in a vehicle in this case is boarding of another user in a vehicle at the time of a user traveling to a destination by the vehicle. A potential effect obtained by ride-sharing in a vehicle with respect to the standpoint described above is different for an urban region and an underpopulated region, for example, but conventionally, there was no method for quantitatively evaluating the effect. Accordingly, conventionally, it was difficult to obtain a clue for determining which region is an appropriate region for deploying a service such as matching for vehicle ride-sharing from the standpoint of cost-effectiveness, for example.

An information processing apparatus according to an aspect of the present disclosure includes a processor. The processor is configured to acquire trip information about trips of a plurality of vehicles in a predetermined region, specify, among the trips of the plurality of vehicles, based on the trip information, a trip with respect to which a travel route of a first vehicle includes a departure point and an arrival point of a travel route of a second vehicle, and generate information indicating an effect of ride-sharing on traffic by assuming establishment of ride-sharing in the first vehicle for the trip that is specified. The trip of a vehicle here means traveling of the vehicle from a departure point to an arrival point. Furthermore, the trip information may include various information pieces regarding a vehicle for one trip, and include a travel route of the vehicle from a departure point to an arrival point, information about a drive history output from the vehicle at the time of traveling, and the like. The drive history may include an operation history of the vehicle by a driver, output information on various sensors mounted in the vehicle, and the like.

With an information processing method according to an aspect of the present disclosure, a computer performs acquiring trip information about trips of a plurality of vehicles in a predetermined region, specifying, among the trips of the plurality of vehicles, based on the trip information, a trip with respect to which a travel route of a first vehicle includes a departure point and an arrival point of a travel route of a second vehicle, and generating information indicating an effect of ride-sharing on traffic by assuming establishment of ride-sharing in the first vehicle for the trip that is specified.

An effect on traffic achieved by establishment of ride-sharing in a vehicle may be grasped by the aspect described above by taking a region where the vehicle travels as a target, and ride-sharing in a vehicle may be expected to be quantitatively evaluated.

In an aspect of the present disclosure, the processor may specify, among the trips of the plurality of vehicles, based on the trip information, a trip with respect to which the travel route of the first vehicle includes the departure point and the arrival point of the travel route of the second vehicle, and a total of number of occupants in the first vehicle and number of occupants in the second vehicle is equal to or smaller than a seating capacity of the first vehicle. Furthermore, in an aspect of the present disclosure, the processor may calculate a number obtained by multiplying number of trips, that are specified, by a predetermined factor as number of cases for which the ride-sharing may be established, and generate the information indicating the effect of the ride-sharing on traffic, based on the number of cases that is calculated. Furthermore, in an aspect of the present disclosure, the processor may determine whether or not to assume that ride-sharing in the first vehicle may be established for the trip that is specified, based on a tolerance for ride-sharing of a driver of at least one of the first vehicle and the second vehicle. Moreover, in an aspect of the present disclosure, the processor may determine whether or not to assume that ride-sharing in the first vehicle may be established for the trip that is specified, based on a congenial between a driver of the first vehicle and an occupant of the second vehicle in matching of the driver and the occupant. Moreover, in an aspect of the present disclosure, the predetermined region may be a region including at least one of a departure point or an arrival point of a travel route of a vehicle indicated by the trip information. Moreover, in an aspect of the present disclosure, the effect of the ride-sharing on traffic may include at least an amount of reduction in a vehicle traffic volume in the predetermined region or an amount of reduction in a travel cost for traveling by a vehicle in the predetermined region.

Hereinafter, a specific embodiment of the present disclosure will be described with reference to the drawings. A configuration of the embodiment below is an example, and the present disclosure is not limited to the configuration of the embodiment.

### First Embodiment

(Outline of System)

In the following, a first embodiment of the present disclosure will be described, citing as an example a case where the present disclosure is applied to an evaluation system for quantitatively evaluating ride-sharing in a vehicle based on drive histories of vehicles. In the present embodiment, an effect on traffic achieved by ride-sharing in a vehicle is evaluated by the evaluation system, taking as a target, a region where a service of ride-sharing in a vehicle is not introduced.

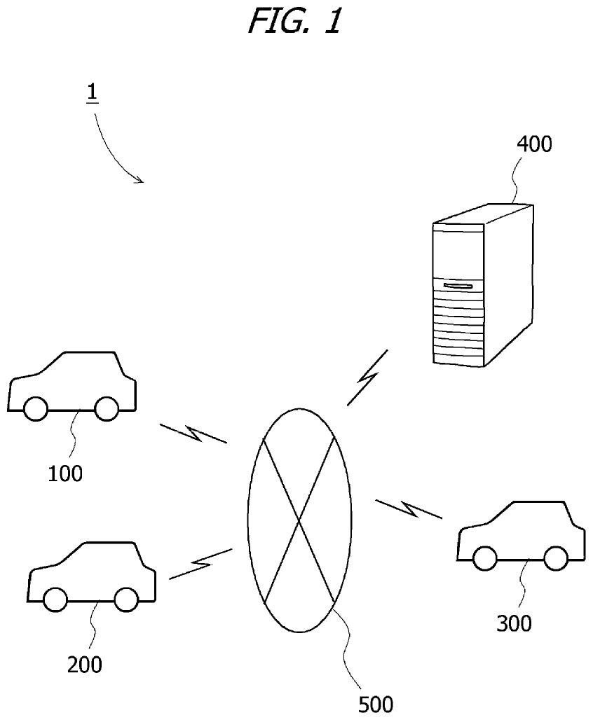

FIG. 1 is a diagram illustrating a schematic configuration of an evaluation system 1 according to the present embodiment. The evaluation system 1 includes vehicles 100, 200, 300, and a management server 400. The number of vehicles included in the evaluation system 1 is not limited to the number mentioned above. In the present embodiment, the vehicles 100, 200, 300 are assumed to travel in a same region. The region is here assumed to be a so-called urban region. Accordingly, in the present embodiment, the number of cases of ride-sharing that are possibly established is calculated based on the trip information on vehicles in an urban region. Additionally, the one region where the vehicles 100, 200, 300 travel corresponds to “predetermined region” according to an aspect of the present disclosure. Trip information on the vehicles 100, 200, 300 is transmitted to the management server 400.

In the evaluation system 1, the vehicles 100, 200, 300 and the management server 400 are interconnected by a network 500. For example, as the network 500, a wide area network (WAN), which is a global public communication network such as the Internet, or other communication networks may be adopted. The network 500 may also include a telephone communication network for mobile phones, and a wireless communication network such as WiFi.

The vehicle 100 includes dedicated communication equipment that stores drive data as the trip information on the vehicle 100, and that communicates with the management server 400. The drive data includes various data pieces related to a drive history regarding traveling of the vehicle 100, such as a vehicle speed at the time of traveling of the vehicle 100, acceleration, drive operations by a user including a brake operation and a steering operation, and measurement values of various sensors. The drive data further includes route data indicating a travel route of the vehicle 100 at the time of traveling. An example of the route data is data associating a time and coordinates, such as latitude and longitude, of a position of the vehicle 100 at the time. Additionally, the route data is data obtained by acquiring coordinates of a vehicle position at specific time intervals or every specific travel distance.

The management server 400 receives the drive data on the vehicle 100 on a regular basis from the dedicated communication equipment mounted in the vehicle 100. To receive the drive data on the vehicle 100 on a regular basis is to receive the drive data on the vehicle 100 at specific time intervals, for example. The drive data on the vehicle 100 may be received every time driving of the vehicle 100 is ended, such as when power of the vehicle 100 is turned off after being turned on, or when a vehicle prime mover of the vehicle 100 is stopped after being started, for example. Additionally, the management server 400 corresponds to “information processing apparatus” according to an aspect of the present disclosure. The vehicles 200, 300 have a same configuration as the vehicle 100, and a description of the configuration of the vehicles 200, 300 is omitted herein.

Furthermore, the management server 400 performs quantitative evaluation process for ride-sharing in the vehicles 100, 200, 300, based on the drive data received from the vehicles 100, 200, 300. A predetermined application for enabling a driver of the vehicles 100, 200, 300 to check contents of evaluation by the management server 400 is installed in the vehicles 100, 200, 300. The driver of the vehicles 100, 200, 300 may check a result of quantitative evaluation of ride-sharing by the management server 400 by activating the application in the vehicles 100, 200, 300. Details of the process at the time of quantitative evaluation of ride-sharing by the management server 400 will be given later.

(System Configuration)

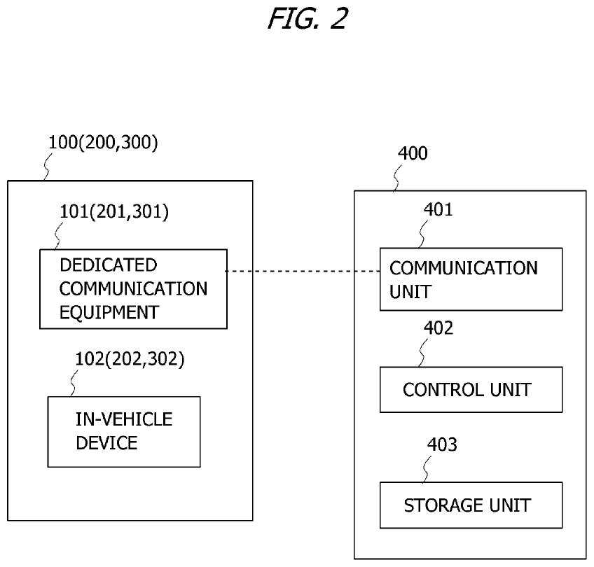

FIG. 2 is a block diagram schematically illustrating an example of a configuration of the vehicles 100, 200, 300 and the management server 400 structuring the evaluation system 1 according to the present embodiment. In the following, a hardware configuration and a functional configuration of the vehicles 100, 200, 300 and the management server 400 will be described with reference to FIG. 2.

(Vehicle)

The vehicle 100 includes dedicated communication equipment 101 as described above, and the drive data regarding traveling of the vehicle 100 is transmitted to the management server 400 by the dedicated communication equipment 101. The vehicle 100 also includes an in-vehicle device 102 that estimates the number of occupants in the vehicle 100. For example, the in-vehicle device 102 is communication equipment that performs communication with a terminal carried by a user riding in the vehicle 100, an in-vehicle camera provided inside the vehicle 100, or a seat sensor or a weight sensor attached to each seat in the vehicle. Additionally, estimation of the number of occupants in the vehicle 100 by the in-vehicle device 102 may be performed by using a known technique, and thus, a detailed description is omitted herein. Data that is generated by the in-vehicle device 102 is also transmitted to the management server 400 by the dedicated communication equipment 101. Additionally, the vehicles 200, 300 have the same configuration as the vehicle 100, and a description thereof is omitted herein.

(Management Server)

Next, a description will be given of the management server 400. The management server 400 is a general computer. That is, the management server 400 is a computer including a processor such as a central processing unit (CPU) or a digital signal processor (DSP), a main memory unit such as a random access memory (RAM) and a read only memory (ROM), and an auxiliary storage unit such as an erasable programmable ROM (EPROM), a hard disk drive (HDD) and a removable medium. The removal medium is a universal serial bus (USB) memory, or a disk recording medium such as a compact disc (CD) or a digital versatile disc (DVD). An operating system (OS), various programs, various tables and the like are stored in the auxiliary storage unit, and each function matching a predetermined object, described later, may be implemented by loading a program stored in the auxiliary storage unit into a work area of the main memory unit and executing the program, and by controlling each structural unit or the like by execution of the program. However, at least one function or all the functions may be implemented by a hardware circuit such as an ASIC or an FPGA. Additionally, the management server 400 may be a single computer, or a plurality of computers cooperating with each other. The management server 400 receives various data pieces from the vehicles 100, 200, 300 over the network 500. Furthermore, the management server 400 performs quantitative evaluation of ride-sharing based on data received from the vehicles 100, 200, 300.

The management server 400 includes a communication unit 401, a control unit 402, and a storage unit 403. The communication unit 401 is communication means for connecting the management server 400 to the network 500. The communication unit 401 includes a local area network (LAN) interface board, or a wireless communication circuit for wireless communication, for example. The control unit 402 is a computer that controls the management server 400. For example, the control unit 402 is a microcomputer, and implements various functions, described later, by executing programs stored in the storage unit 403 by the CPU. The storage unit 403 stores various data pieces received from the vehicles 100, 200, 300, and data indicating a result of quantitative evaluation of ride-sharing, for example.

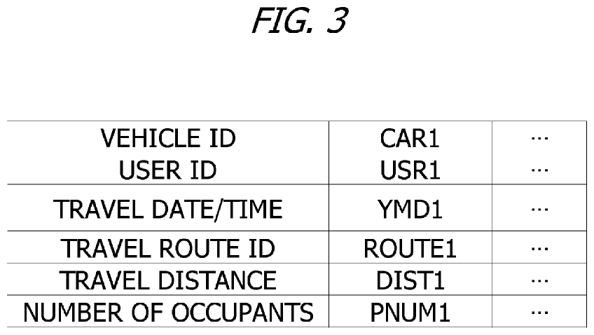

FIG. 3 illustrates a structure of a drive history information table that is stored in the storage unit 403 of the management server 400. The drive history information table is a table storing various information pieces regarding a drive history of the vehicle 100. The management server 400 stores information in each section of the drive history information table illustrated in FIG. 3, based on the drive data received from the vehicles 100, 200, 300.

A vehicle ID is identification information for uniquely identifying a vehicle (“CAR1” in the drawing) in the evaluation system 1 of the present embodiment. A user ID is identification information for identifying the driver of the vehicle (“USR1” in the drawing). Travel date/time is information indicating date/time when the vehicle travelled (“YMD1” in the drawing). A travel route ID is identification information for uniquely identifying a route the vehicle travelled (“ROUTE1” in the drawing). A travel distance is information indicating a travel distance of the vehicle traveling in a travel section (“DIST1” in the drawing). The number of occupants is information indicating the number of occupants in the vehicle during traveling (“PNUM1” in the drawing), estimated based on data output by the in-vehicle device, mounted in the vehicle, for estimation of the number of occupants. In the drive history information table, information pieces in the respective sections for one travel are stored in association with each other.

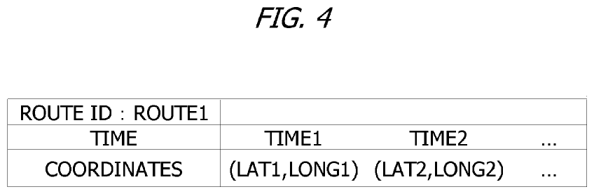

FIG. 4 illustrates a structure of a travel history information table that is stored in the storage unit 403 of the management server 400. The travel history information table is a table storing history information regarding a travel route of the vehicles 100, 200, 300. As illustrated in FIG. 4, the travel history information table stores, in association with each other, the travel route ID in the drive history information table in FIG. 3 (“ROUTE1” in the drawing), a time (“TIME1” in the drawing), and a set of coordinates of a vehicle position (latitude such as “LAT1” in the drawing and longitude such as “LONG1” in the drawing). In the present embodiment, data pieces about the time and the coordinates of the vehicle position to be stored in the travel history information table are included in the drive data that the management server 400 receives from the vehicles 100, 200, 300. Additionally, in the present embodiment, information pieces about the time and the coordinates of the vehicle position on the travel route are stored in a table different from the drive history information table, but the structures of the tables storing respective information pieces described above are not limited to those illustrated in FIGS. 3 and 4.

(Processing Flow)

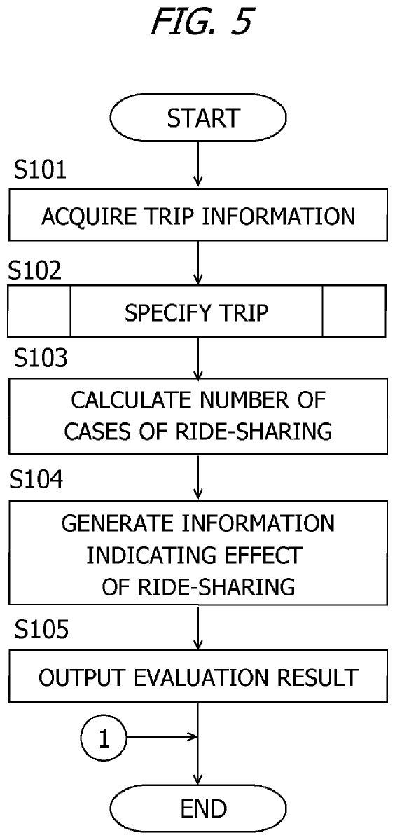

In the following, a processing flow of the evaluation system 1 of the present embodiment will be described with reference to FIG. 5. In the present embodiment, the number of cases for which ride-sharing using the vehicles 100, 200, 300 may be established is calculated based on the trip information on the vehicles 100, 200, 300, by the control unit 402 of the management server 400 performing the process in FIG. 5. The management server 400 further calculates a vehicle traffic volume in a region where the vehicles 100, 200, 300 travelled, based on the calculated number of cases for which ride-sharing may be established.

First, in S101, the control unit 402 of the management server 400 acquires the trip information on the vehicles 100, 200, 300. Specifically, the control unit 402 communicates with the dedicated communication equipment 101, 201, 301 of the vehicles 100, 200, 300, and receives the drive data on the vehicles 100, 200, 300. The control unit 402 stores each information piece included in the received drive data in the respective section in the drive history information table and the travel history information table described above. Additionally, a case is conceivable where the drive data does not include information pieces corresponding to the respective sections. In this case, the control unit 402 may calculate the information pieces corresponding to the respective sections based on the received drive data, and may store the calculated information pieces in the respective sections. For example, the control unit 402 estimates the number of occupants during traveling, based on output data on the in-vehicle device 102, 202, 302 of the vehicles 100, 200, 300 included in the drive data, and stores the estimated number of occupants in the “number of occupants” section in the drive history information table.

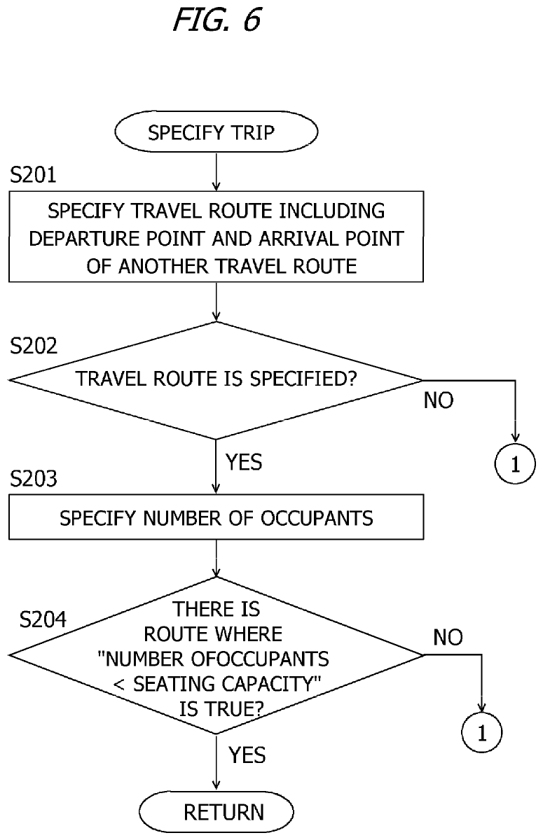

Next, in S102, the control unit 402 performs a process for specifying a trip, based on information associated with the vehicles 100, 200, 300 stored in the drive history information table in S101. A subroutine to be performed by the control unit 402 in S102 is illustrated in FIG. 6. In the following, a process for specifying a trip to be performed by the control unit 402 in S102 will be described with reference to FIG. 6. Additionally, “1” in the flow in FIG. 6 leads to “1” in FIG. 5, respectively.

First, in S201, the control unit 402 specifies a travel route of each vehicle based on the information stored in the drive history information table. In a specific example process, the control unit 402 acquires each travel route ID stored in the drive history information table, and acquires, from the travel history information table, the time and the coordinates of the vehicle position that are stored in association with the acquired travel route ID. Then, the control unit 402 specifies a travel route that includes a departure point and an arrival point of another travel route, based on the acquired coordinates of the vehicle position of each travel route. The travel route that is specified at this time corresponds to “travel route of a first vehicle including a departure point and an arrival point of a travel route of a second vehicle” according to an aspect of the present disclosure.

Next, in S202, the control unit 402 determines whether or not a travel route that includes a departure point and an arrival point of another travel route is specified by the process in S202. In the case where a travel route that includes a departure point and an arrival point of another travel route is specified (S202: Yes), the control unit 402 proceeds to S203. On the other hand, in the case where a travel route that includes a departure point and an arrival point of another travel route is not specified (S202: No), the control unit 402 ends the process of the present flowchart (from “1” in FIG. 6 to “1” in FIG. 5).

Next, in S203, the control unit 402 acquires, from the drive history information table, the drive history of the travel route that is specified in S201, or in other words, each travel route including a departure point and an arrival point of another travel route. Then, the control unit 402 specifies, based on the acquired drive history, or more specifically, information that is stored in the “number of occupants” section in the present embodiment, the number of occupants in the vehicle at the time of traveling, for each travel route that includes a departure point and an arrival point of another travel route.

Next, in S204, whether or not there is a travel route where the number of occupants in the vehicle specified in S203 is less than a seating capacity of the vehicle in question. In the case where there is a travel route where the number of occupants in the vehicle is less than the seating capacity (S204: Yes), the control unit 402 ends the present subroutine and proceeds to S103. On the other hand, in the case where there is no travel route where the number of occupants in the vehicle is less than the seating capacity (S204: No), the control unit 402 ends the process of the present flowchart (from “1” in FIG. 6 to “1” in FIG. 5). The processes from S201 to S204 described above correspond to “specification, among the trips of the plurality of vehicles, based on the trip information, of a trip with respect to which the travel route of the first vehicle includes the departure point and the arrival point of the travel route of the second vehicle, and a total of the number of occupants in the first vehicle and the number of occupants in the second vehicle is equal to or smaller than a seating capacity of the first vehicle” according to an aspect of the present disclosure.

In S103, the control unit 402 determines that ride-sharing in a vehicle may be established for the trip specified by the process in S102. Then, the control unit 402 calculates the number of specified trips as the number of cases for which ride-sharing may be established.

Ride-sharing is possibly not established for a trip for which the number of occupants in the vehicle is less than the seating capacity, among the trips specified by the process in S102. Accordingly, for example, the control unit 402 may calculate, as the number of cases, a number that is obtained by multiplying the number of trips specified by the process in S102 by a factor of one or less and by rounding up or cutting off decimals as appropriate. The factor may be determined based on statistics, such as the number of cases of ride-sharing established in the past in the region where the vehicles 100, 200, 300 travel, for example.

Furthermore, in S103, the control unit 402 may calculate the number of cases of ride-sharing, based on a tolerance for ride-sharing of each driver of the vehicle. The tolerance for ride-sharing in this case includes at least one of an index indicating willingness of a driver to provide his/her vehicle as a vehicle for ride-sharing, or an index indicating willingness of a driver to use ride-sharing in another vehicle. Accordingly, it can be said that ride-sharing is more likely to be established, the higher the tolerance. For example, the number of cases of ride-sharing may be calculated for each travel route where the number of occupants in the vehicle is less than the seating capacity, among the trips specified by the process in S102, by making the factor described above closer to one, the higher the tolerance for ride-sharing of the driver of the vehicle. Additionally, information about the tolerance of each driver for ride-sharing may be acquired by the management server 400 and be stored in the storage unit 403 in advance.

Furthermore, the control unit 402 may calculate the number of cases of ride-sharing based on a congenial between a user as a driver and a user as a ride-sharing passenger in matching for ride-sharing in a vehicle. A method of matching in this case may be a method which is performed by using a known technique. Furthermore, a congenial between users may be a condition, according to demands of users, regarding a driver or a vehicle to be used for ride-sharing. For example, such a condition is that baggage can be loaded in the vehicle, or that the driver is a female. Furthermore, in the case where there is feedback for the driver of a vehicle from a user who used ride-sharing, the feedback being at or higher than a predetermined reference may be included in the condition. For example, in the case where the vehicle or the driver satisfies the condition as described above for the trip specified by the process in S102, the control unit 402 assumes that ride-sharing may be established, and counts the number of cases of ride-sharing for the trip as one case. Additionally, the method of using each information piece such as the factor, the tolerance, or the congenial in calculation of the number of cases of ride-sharing is not limited to the method described. In the present embodiment, a realistic number of cases of established ride-sharing for a trip may be calculated by using each information piece such as the factor, the tolerance, or the congenial.

Next, in S104, the control unit 402 generates information indicating an effect, on traffic, of ride-sharing which is assumed to be established for the trip. Specifically, the control unit 402 calculates the number of traveling vehicles that are reduced by ride-sharing, in the region where the vehicles 100, 200, 300 travel, based on the number of cases of ride-sharing calculated in S103. Furthermore, the control unit 402 may calculate, based on the process in S103, a degree of alleviation of congestion on the travel route of each traveling vehicle due to reduction by ride-sharing, an amount of reduction in vehicle traffic volume from standpoints including an amount of carbon dioxide emissions from vehicles, and an amount of reduction in travel cost (such as fuel cost and toll road fee) for traveling by a vehicle. Additionally, the amount of reduction in vehicle traffic volume that is calculated in S104 corresponds to “information indicating an effect of ride-sharing on traffic” according to an aspect of the present disclosure. The control unit 402 may quantitatively evaluate an effect of ride-sharing using the vehicles 100, 200, 300 in the manner described above.

In S105, the control unit 402 outputs processing result of S104 to a monitor or the like of the management server 400, for example, as a quantitative evaluation result of an effect of ride-sharing in a vehicle. A user of the management server 400 may check, based on the output evaluation result, the number of cases of ride-sharing which is possibly established in the travel region of the vehicles or an effect of ride-sharing on the vehicle traffic volume. Moreover, for example, a travel region of a plurality of vehicles may be divided into a plurality of regions, and the process described above may be performed by the management server 400 for each region to perform quantitative comparison of the effects of ride-sharing in a vehicle in respective regions. Then, a quantitative evaluation result for each region may be used to determine which is the region where the service of ride-sharing in a vehicle is effectively deployed.

As described above, according to the present embodiment, information regarding the degree of effect (merit) that can be obtained by use of ride-sharing may be provided for an arbitrary target region, for example. Moreover, a business operator providing the service of ride-sharing may use the evaluation result of the present embodiment to determine in which region to introduce the service.

### Other Embodiments

The embodiment described above is an example, and the present disclosure may be changed and carried out as appropriate without departing from the gist of the present disclosure.

For example, in the embodiment described above, that vehicles are traveling in a same travel region may mean that departure points and arrival points in the travel histories of the vehicles are both included in the travel region. Alternatively, vehicles may be assumed to be traveling in a same travel region if at least the departure points or the arrival points in the travel histories of the vehicles are included in the travel region. Accordingly, whether ride-sharing is possible on a route may be determined and quantitative evaluation of ride-sharing in a vehicle may be performed based on the determination, even in a case of a route from outside a travel region into the travel region or a route from inside a travel region to outside the travel region, without being limited to a route according to which the travel route of a vehicle is completed within a travel region.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to:
acquire trip information about trips of a plurality of vehicles in a predetermined region;
specify, among the trips of the plurality of vehicles, based on the trip information, a trip with respect to which a travel route of a first vehicle includes a departure point and an arrival point of a travel route of a second vehicle, wherein the first vehicle and the second vehicle are included in the plurality of vehicles; and
generate information indicating an effect of ride-sharing on traffic by assuming establishment of ride-sharing in the first vehicle for the trip that is specified.

2. The information processing apparatus according to claim 1, wherein the processor is configured to specify, among the trips of the plurality of vehicles, based on the trip information, a trip with respect to which the travel route of the first vehicle includes the departure point and the arrival point of the travel route of the second vehicle, and a total of a number of occupants in the first vehicle and a number of occupants in the second vehicle is equal to or smaller than a seating capacity of the first vehicle.

3. The information processing apparatus according to claim 1, wherein the control unit is configured to:
calculate a number obtained by multiplying number of trips, that are specified, by a predetermined factor as number of cases for which the ride-sharing may be established, and
generate the information indicating the effect of the ride-sharing on traffic, based on the number of cases that is calculated.

4. The information processing apparatus according to claim 1, wherein the processor is configured to determine whether or not to assume that ride-sharing in the first vehicle may be established for the trip that is specified, based on a tolerance of a driver of at least one of the first vehicle and the second vehicle for ride-sharing.

5. The information processing apparatus according to claim 1, wherein the processor is configured to determine whether or not to assume that ride-sharing in the first vehicle may be established for the trip that is specified, based on a congenial between a driver of the first vehicle and an occupant of the second vehicle in matching of the driver and the occupant.

6. The information processing apparatus according to claim 1, wherein the predetermined region is a region including at least one of a departure point or an arrival point of a travel route of a vehicle indicated by the trip information.

7. The information processing apparatus according to claim 1, wherein the effect of the ride-sharing on traffic includes at least an amount of reduction in a vehicle traffic volume in the predetermined region or an amount of reduction in a travel cost for traveling by a vehicle in the predetermined region.

8. An information processing method performed by a computer, the method comprising:
acquiring trip information about trips of a plurality of vehicles in a predetermined region;
specifying, among the trips of the plurality of vehicles, based on the trip information, a trip with respect to which a travel route of a first vehicle includes a departure point and an arrival point of a travel route of a second vehicle, wherein the first vehicle and the second vehicle are included in the plurality of vehicles; and
generating information indicating an effect of ride-sharing on traffic by assuming establishment of ride-sharing in the first vehicle for the trip that is specified.

9. A non-transitory computer-readable program for causing a computer to perform:
acquiring trip information about trips of a plurality of vehicles in a predetermined region;
specifying, among the trips of the plurality of vehicles, based on the trip information, a trip with respect to which a travel route of a first vehicle includes a departure point and an arrival point of a travel route of a second vehicle, wherein the first vehicle and the second vehicle are included in the plurality of vehicles; and
generating information indicating an effect of ride-sharing on traffic by assuming establishment of ride-sharing in the first vehicle for the trip that is specified.
